(19) United States
(12) Patent Application Publication
(10) Pub. No.: US 2009/0171660 A1
(43) Pub. Date: Jul. 2, 2009

(54) METHOD AND APPARATUS FOR VERIFICATION OF SPEAKER AUTHENTIFICATION AND SYSTEM FOR SPEAKER AUTHENTICATION

(75) Inventors: Luan JIAN, Beijing (CN); Hao Jie, Beijing (CN)

Correspondence Address: Charles N.J. Ruggiero, Esq.;Ohlandt, Greeley, Ruggiero & Perle, L.L.P., 10th Floor, One Landmark Square,, Stamford, CT, 06901-2682, US

(73) Assignee: KABUSHIKI KAISHA TOSHIBA

(21) Appl. No.: 12/338,906

(22) Filed: Dec. 18, 2008

(30) Foreign Application Priority Data
Dec. 20, 2007 (CN) 200710199192.3

(51) Int. Cl. G10L 17/00

(52) U.S. Cl. 704/246; 704/E17.001

(57) ABSTRACT

A method for verification of speaker authentication comprises inputting a test utterance containing a password that is spoken by a speaker, extracting an acoustic feature vector sequence from the inputted test utterance, obtaining a matching path between the extracted acoustic feature vector sequence and a speaker template enrolled by an enrolled speaker, calculating a matching score of the obtained matching path upon considering spectral change of the test utterance and/or spectral change of the speaker template, and comparing the matching score with a predefined discriminating threshold to determine whether the inputted test utterance is an utterance containing a password spoken by the enrolled speaker.

### CROSS-REFERENCE TO RELATED APPLICATIONS

This application is based upon and claims the benefit of priority from prior Chinese Patent Application No. 200710199192.3, filed Dec. 20, 2007, the entire contents of which are incorporated herein by reference.

### BACKGROUND OF THE INVENTION

1. Field of the Invention

The present invention relates to information processing technology, specifically to the technology of speaker authentication.

2. Description of the Related Art

By using pronunciation features of each speaker when he/she is speaking, different speakers may be identified, so as to make speaker authentication. In the article “Speaker recognition using hidden Markov models, dynamic time warping and vector quantisation” written by K. Yu, J. Mason, J. Oglesby (Vision, Image and Signal Processing, IEE Proceedings, Vol. 142, October 1995, pp. 313-318), commonly used three kinds of speaker identification engine technologies have been introduced: HMM (Hidden Markov Model), DTW (Dynamic Time Warping) and VQ (Vector Quantization) (referred to article 1 hereafter), all of which are incorporated herein by reference.

Generally, a speaker authentication system includes two phases: enrollment and verification. In the phase of enrollment, a speaker template of a speaker (client) is produced according to an utterance containing a password that is spoken by the speaker; in the phase of verification, it is determined according to the speaker template whether the testing utterance is an utterance containing the same password spoken by the speaker. Specifically, a DTW algorithm is usually used in the phase of verification to DTW-match an acoustic feature vector sequence of the testing utterance and a speaker template to obtain a matching score, and the matching score is compared with a discriminating threshold obtained in the phase of enrollment to determine whether the testing utterance is an utterance containing the same password spoken by the speaker. In the DTW algorithm, a common way to calculate a global matching score between an acoustic feature vector sequence of a testing utterance and a speaker template is to add up all local distances along an optimal matching path directly. The detail description of the DTW-based speaker verification can be seen in the article “Cepstral analysis technique for automatic speaker verification” written by S. Furui, Acoustics, Speech, and Signal Processing, (1981), Vol. 29, No. 2, pp. 254-271, all of which is incorporated herein by reference.

Generally, some frames in the utterance of the password spoken by the speaker may be more discriminative than others for the speaker and thus their relevant frame distances will be more critical in verifying the speaker. It may be expected to improve the system performance by emphasizing such frame distances in calculating the global matching score.

Now, as a normal method of weighting frames, a speaker template is tested to determine the discriminability of each frame by using two big sets of utterance data of clients and impostors, the detail description of which can be seen in the article “Enhancing the stability of speaker verification with compressed templates” written by X. Wen and R. Liu, 2002, ISCSLP2002, pp. 111-114, all of which is incorporated herein by reference. The inventors of the present invention have also proposed a method of weighting frames based on phone (or sub-word unit) recognition in Chinese patent application No. 200510114901.4. That is, an incoming utterance is parsed into a phone transcription by a phone recognizer (or classifier) and then weights may be put for frames of the incoming utterance according to a prior knowledge on the speaker discriminability of phones or classes of phones. The detail description of the method of weighting frames can be seen in Chinese patent application No. 200510114901.4, all of which is incorporated herein by reference.

In the first method, a large amount of development data (two big sets of utterance data containing a same password spoken by the speaker and spoken by other people respectively) is needed to test the speaker template. Therefore, it costs a lot of time for enrolling, and the users can not change the password themselves without the help of the vendor. Thus, it is very inconvenient for the users to use the system. In the latter method, the phone recognizer is necessary in the front end. Therefore, it is suitable for HMM-based systems since HMMs themselves may be effective models for phones. However, for DTW-based systems, the phone recognizer will have to cause extra memory requirement and computation burden.

Therefore, there is a need to provide a method of evaluating the speaker-discriminability automatically for each frame of utterance of a password without extra development data.

### BRIEF SUMMARY OF THE INVENTION

According to embodiments of the present invention, there is provided a method for verification of speaker authentication, an apparatus for verification of speaker authentication and a system for speaker authentication.

According to an aspect of the present invention, there is provided a method for verification of speaker authentication, comprising: inputting a test utterance containing a password that is spoken by a speaker; extracting an acoustic feature vector sequence from the inputted test utterance; obtaining a matching path between the extracted acoustic feature vector sequence and a speaker template enrolled by an enrolled speaker; calculating a matching score of the obtained matching path upon considering spectral change of the test utterance and/or spectral change of the speaker template; and comparing the matching score with a predefined discriminating threshold to determine whether the inputted test utterance is an utterance containing a password spoken by the enrolled speaker.

According to another aspect of the present invention, there is provided a method for verification of speaker authentication, comprising: inputting a test utterance containing a password that is spoken by a speaker; extracting an acoustic feature vector sequence from the inputted test utterance; obtaining a matching path between the extracted acoustic feature vector sequence and a speaker template enrolled by an enrolled speaker upon considering spectral change of the test utterance and/or spectral change of the speaker template; calculating a matching score of the obtained matching path; and comparing the matching score with a predefined discriminating threshold to determine whether the inputted test utterance is an utterance containing a password spoken by the enrolled speaker.

According to another aspect of the present invention, there is provided an apparatus for verification of speaker authentication, comprising: a test utterance inputting unit configured to input a test utterance containing a password that is spoken by a speaker; an acoustic feature vector sequence extractor configured to extract an acoustic feature vector sequence from the inputted test utterance; a matching path obtaining unit configured to obtain a matching path between the extracted acoustic feature vector sequence and a speaker template enrolled by an enrolled speaker; a matching score calculator configured to calculate a matching score of the obtained matching path upon considering spectral change of the test utterance and/or spectral change of the speaker template; and a comparing unit configured to compare the matching score with a predefined discriminating threshold to determine whether the inputted test utterance is an utterance containing a password spoken by the enrolled speaker.

According to another aspect of the present invention, there is provided an apparatus for verification of speaker authentication, comprising: a test utterance inputting unit configured to input a test utterance containing a password that is spoken by a speaker; an acoustic feature vector sequence extractor configured to extract an acoustic feature vector sequence from the inputted test utterance; a matching path obtaining unit configured to obtain a matching path between the extracted acoustic feature vector sequence and a speaker template enrolled by an enrolled speaker upon considering spectral change of the test utterance and/or spectral change of the speaker template; a matching score calculator configured to calculate a matching score of the obtained matching path; and a comparing unit configured to compare the matching score with a predefined discriminating threshold to determine whether the inputted test utterance is an utterance containing a password spoken by the enrolled speaker.

According to another aspect of the present invention, there is provided a system for speaker authentication, comprising: an enrollment apparatus configured to enroll a speaker template; and the apparatus for verification of speaker authentication mentioned-above configured to verify a test utterance based on the speaker template enrolled by the enrollment apparatus.

### BRIEF DESCRIPTION OF THE SEVERAL VIEWS OF THE DRAWING

FIG. 1 is a flowchart showing a method for verification of speaker authentication according to a first embodiment of the present invention;

FIG. 2 is a flowchart showing a method for verification of speaker authentication according to a second embodiment of the present invention;

FIG. 3 shows an example of a DTW-matching between a test utterance and a speaker template;

FIG. 4 is a block diagram showing an apparatus for verification of speaker authentication according to a third embodiment of the present invention;

FIG. 5 is a block diagram showing an apparatus for verification of speaker authentication according to a fourth embodiment of the present invention; and

FIG. 6 is a block diagram showing a system for speaker authentication according to a fifth embodiment of the present invention.

### DETAILED DESCRIPTION OF THE INVENTION

Next, a detailed description of the preferred embodiments of the present invention will be given in conjunction with the drawings.

Method for verification of speaker authentication

### First Embodiment

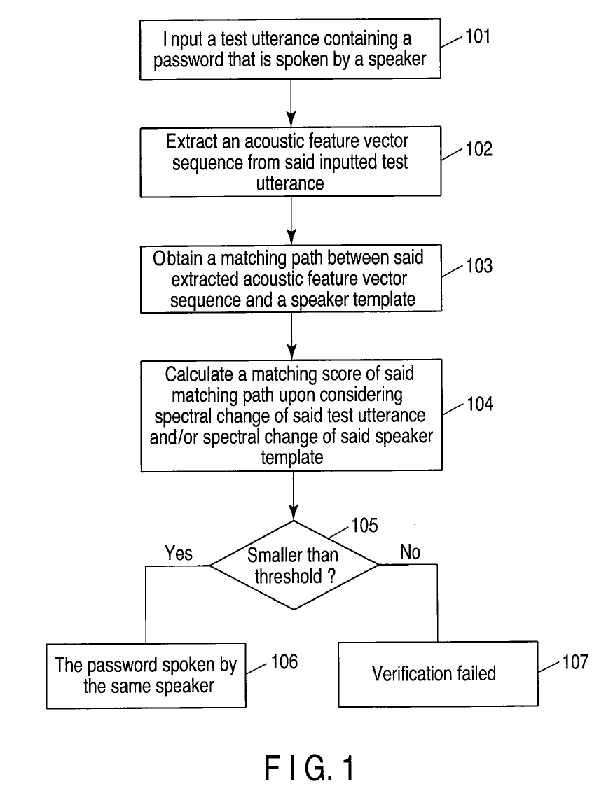

FIG. 1 is a flowchart showing a method for verification of speaker authentication according to the first embodiment of the present invention. Next, the embodiment will be described in conjunction with the drawing.

As shown in FIG. 1, first in step 101, a test utterance containing a password is inputted by a client needed to be verified, wherein the password is a special term or phoneme sequence that is set by a client for verification in a phase of enrollment.

Next, in step 102, an acoustic feature vector sequence is extracted from the test utterance inputted in step 101. The invention has no specific limitation to the way to express an acoustic feature, and it may be, for example, MFCC (Mel-scale Frequency Cepstral Coefficients), LPCC (Linear Predictive Cepstrum Coefficient) or other coefficients obtained based on energy, fundamental tone frequency, or wavelet analysis, as long as it can express personal utterance characteristics of a speaker; however, it should be corresponded with the way used to express an acoustic feature in the phase of enrollment.

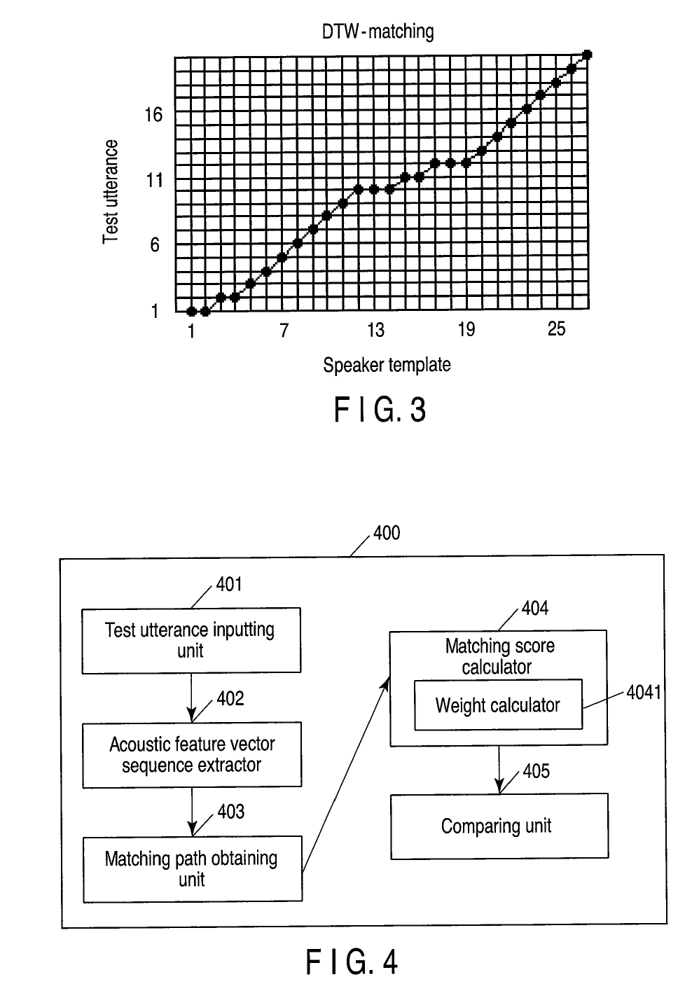

Next, in step 103, the acoustic feature vector sequence extracted in step 102 and a speaker template enrolled by an enrolled speaker is matched and a matching path is obtained. Specifically, for a HMM model, the matching path can be obtained by matching based on frequency, the detail description of which can be seen in above article 1. For a DTW model, the matching path can be obtained by the DTW algorithm, the detail description of which will be given in follows by reference of FIG. 3.

FIG. 3 shows an example of DTW-matching between a test utterance and a speaker template. As shown in FIG. 3, the horizontal axis represents frames of the speaker template, and the vertical axis represents frames of the inputted utterance. When the DTW-matching is performed, local distances between each frame of the speaker template and a corresponding frame of the inputted utterance and adjacent frames thereof are calculated, and the frame of the inputted utterance, which has the smallest local distance, is selected as the frame corresponding to the frame of the speaker template. The step is repeated until each of all frames of the inputted utterance is found a corresponding frame of the speaker template, thereby an optimal matching path can be obtained, wherein the optimal matching path is a matching path with a lowest distance between the acoustic feature vector sequence of the inputted utterance and the speaker template, and the matching path is a path from a point (1, 1) to a point (I, J) along a grid as shown in FIG. 3, wherein I is the number of frames of the inputted utterance and J is the number of frames of the speaker template. It should be understood that the method of the embodiment can be used in any known model besides the HMM model and the DTW model as long as the optimal matching path between the acoustic feature vector sequence extracted in step 102 and the speaker template can be obtained.

The speaker template in this embodiment is a speaker template generated by a method for enrollment of speaker authentication, which includes at least acoustic features corresponding to the password utterance and a discriminating threshold. The process for enrollment of speaker authentication will be described simply herein. First, an utterance containing the password spoken by the speaker is inputted. Next, an acoustic feature is extracted from the inputted password utterance. Then, the speaker template is produced. The speaker template can be built with a number of utterances for training in order to improve the quality of the speaker template. First, a training utterance is selected to be an initial template. Then, a second training utterance is aligned with the initial template by DTW method, and a new template is produced with the average of the corresponding feature vectors in the two utterances. Then, a third training utterance is aligned with the new template by the DTW method. The above process is repeated until all training utterances are merged to single template, that is, so-called template merging is made. About template merging, reference may be made to the article “Cross-words reference template for DTW-based speech recognition systems” written by W. H. Abdulla, D. Chow, and G. Sin(IEEE TENCON 2003, pp. 1576-1579).

Moreover, in the phase of enrollment of speaker authentication, the discriminating threshold contained in the speaker template can be determined in the following manner. First, two distributions of DTW-matching scores of the speaker and other people are obtained by collecting two big sets of utterance data containing a same password spoken by the speaker and spoken by other people respectively, and DTW-matching the two sets of utterance data with the trained speaker template, respectively. Then, the discriminating threshold for the speaker template can be estimated in at least the following three ways:

setting the discriminating threshold to the cross point of the two distribution curves, that is, the place where the sum of FAR (False Accept Rate) and FRR (False Reject Rate) is minimum;

setting the discriminating threshold to the value corresponding to EER (Equal Error Rate); or

setting the discriminating threshold to the value that makes false accept rate a desired value (such as 0.1%).

Back to FIG. 1, next, in step 104, a matching score of said matching path obtained in step 103 is calculated upon considering spectral change of said test utterance and/or spectral change of said speaker template.

In step 104, first, weights for each frame of said matching path are calculated based on the spectral change of said test utterance and/or the spectral change of said speaker template.

Specifically, in the embodiment, that frames during rapid spectral change period are given high weights and that frames during low spectral change period are given low weights. That is to say, in the embodiment, that frames during rapid spectral change period are emphasized.

The method of calculating the weights for each frame of said matching path by using the spectral change in step 104 will be described in detail in follows by reference of examples 1-3.

### Example 1

In example 1, the weights for each frame of said matching path are measured by feature distances between the target frame and its neighboring frames along a time sequence.

First, the spectral change for each frame of the speaker template X and the test utterance Y are measured respectively.

Specifically, the spectral change dₓ(i) of the speaker template X is calculated by formula (1):

dₓ(i)=(dist(xᵢ,xᵢ₋₁)+dist(xᵢ,xᵢ₊₁))/2 (1)

wherein i is an index of a frame of the speaker template X, x is a feature vector of the speaker template X, dist is a distance such as an Euclid distance between two feature vectors.

It should be understood that although the spectral change dₓ(i) of the speaker template X is measured by the arithmetical average value of feature distances dist(xᵢ, xᵢ₋₁) and dist(xᵢ, xᵢ₊₁) between the target frame and its neighboring frames along a time sequence, the present invention is not limited to this and the spectral change dₓ(i) can be measured by the geometrical average value \sqrt{dist(xᵢ,xᵢ₋₁)×dist(xᵢ,xᵢ₊₁)} or the harmonic average value 1/(1/dist(xᵢ, xᵢ₋₁)+1/dist(xᵢ, xᵢ₊₁)) of feature distances dist(xᵢ, xᵢ₋₁) and dist(xᵢ, xᵢ₊₁) etc., as long as the spectral change of the speaker template X is sufficiently embodied.

Further, it should be understood that although the spectral change on the target frame is measured by the two distances dist(xᵢ, xᵢ₋₁) and dist(xᵢ, xᵢ₊₁), the present invention is not limited to this and more distances between the target frame and its neighboring frames along a time sequence can be used.

Similarly, the spectral change d_{y}(i) of the test utterance Y can be measured by using the above method of calculating the spectral change dₓ(i) of the speaker template X based on the acoustic feature vector sequence extracted in step 102, wherein j is an index of a frame of the acoustic feature vector sequence of the test utterance Y.

Then, the weights for each frame of the matching path are calculated by a monotone increasing function of the spectral change dₓ(i) of the speaker template X and the spectral change d_{y}(i) of the test utterance Y. For example, the weights w(k) for each frame of the matching path can be calculated by using the following formula (2) to formula (4):

w(k)=d(k)+c (2)

w(k)=d(k)^{a}+c (3)

w(k)=log(d(k)+c) (4)

wherein k is an index of a frame pair of the matching path, which corresponds to the index i of the frame of the speaker template X and the index j of the frame of the test utterance Y, a and c are constant, and d(k) is one of dₓ(i), d_{y}(j), and any combination thereof such as (dₓ(i)+d_{y}(j))/2, \sqrt{dₓ(i)×d_{y}(j)}, min(dₓ(i),d_{y}(j)), max(dₓ(i),d_{y}(j)) etc.

### Example 2

In example 2, the weights for each frame of the matching path are measured by segments obtained by using a code book.

The code book used in the present embodiment is one trained in the acoustic space of a whole application. For example, for a Chinese language application environment, the code book needs to cover the acoustic space of Chinese utterances; and for an English language application environment, the code book needs to cover the acoustic space of English utterances. Of course, for some special application environments, the acoustic space covered by the code book can be changed correspondingly.

The code book of the present embodiment contains a lot of codes and their corresponding feature vectors. The number of the codes depends on the size of the acoustic space, desired compression ratio and desired compression quality. The greater the acoustic space is, the more the number of the needed codes is. Under a condition of a same acoustic space, the less the number of the codes is, the higher the compression ratio is, and the more the number of the codes is, the higher the quality of the compressed template is. According to a preferred embodiment of the present invention, under an acoustic space of common Chinese utterances, the number of the codes is preferably 256-512. Of course, according to different needs, the number of the codes and the covered acoustic space of the code book can be adjusted appropriately.

In example 2, first, each frame of the acoustic feature vector sequence of the test utterance is labeled with a nearest code in the code book. Then, the test utterance is segmented based on the labels such that all the frames in one segment have a same label. Since the frames in a segment are similar with each other, the length of each segment may also be regarded as a kind of measurement for spectral change. Longer segment indicates slower spectral change at that place. Similarly, the spectral change of the speaker template can be measured by the length of each segment obtained by labeling each frame of the speaker template by using the code book and segmenting the speaker template based on the labels obtained.

In example 2, the weights for each frame of the matching path can be calculated by using the formula (2) to formula (4) in example 1 except that dₓ(i) and d_{y}(j) are lengths of the segment where the target frame is located and therefore are discrete values. In this case, piecewise functions can be used as the functions used to transform spectral change into weights for each frame of the matching path.

In the present embodiment, any type of piecewise functions can be used, such as w(k)=1, if d(k)≦10; w(k)=0.5, else, wherein k is an index of a frame pair of the matching path, which corresponds to the index i of the frame of the speaker template X and the index j of the frame of the test utterance Y, and d(k) is one of dₓ(i), d_{y}(j), and any combination thereof such as (dₓ(i)+d_{y}(j))/2, \sqrt{dₓ(i)×d_{y}(j)}, min(dₓ(i),d_{y}(j)), max(dₓ(i),d_{y}(j)) etc., and the present invention has no limitation on this.

### Example 3

In example 3, the weights for each frame of said matching path are measured by feature distances between the target frame and frames in its neighboring nodes along said matching path.

Specifically, the spectral change dₓ(i) of the speaker template X is calculated by formula (5):

dₓ(i)=dₓ(φₓ(k))=(dist(x_{φ}_{ₓ}₍ₖ₎,x_{φ}_{ₓ}₍ₖ₋₁₎)+dist(x_{φ}_{ₓ}₍ₖ₎,x_{φ}_{ₓ}₍ₖ₊₁₎))/2 (5)

wherein i is the index of a frame of the speaker template X, k is an index of a frame pair along the matching path φ, φₓ(k) is the index of the frame of the speaker template X corresponding to the kth frame pair of the matching path φ, x is a feature vector of the speaker template X, dist is a distance such as an Euclid distance between two feature vectors.

It should be understood that although the spectral change of the speaker template X is measured by using the formula (5) with the arithmetical average value of feature distances between the target frame and frames in its neighboring nodes along said matching path, the present invention is not limited to this and the spectral change can be measured by the geometrical average value or the harmonic average value of feature distances etc., as long as the spectral change of the speaker template X is sufficiently embodied.

Further, it should be understood that although the spectral change on the target frame is measured by the two distances between the target frame and frames in its nearest neighboring nodes along said matching path, the present invention is not limited to this and more distances between the target frame and frames in its neighboring nodes along said matching path can be used.

Similarly, the spectral change d_{y}(i) of the test utterance Y can be measured by using the above method of calculating the spectral change dₓ(i) of the speaker template X with the formula (5) based on the acoustic feature vector sequence extracted in step 102, wherein j is an index of a frame of the acoustic feature vector sequence of the test utterance Y.

Then, the weights for each frame of the matching path are calculated by a monotone increasing function of the spectral change dₓ(i) of the speaker template X and the spectral change d_{y}(i) of the test utterance Y. For example, the weights w(k) can be calculated by using the above formula (2) to formula (4), the detail description of which is omitted herein for clarity.

Although the weights for each frame of the matching path are calculated by the methods described by using examples 1-3, the present invention is not limited to examples 1-3, and any method for measuring the weights for each frame of the matching path by using spectral change can be used, as long as rapid and low spectral change can be transformed into high and low weights, and the present invention has no limitation on this.

It should be understood that in the methods described by using examples 1-3, the weights for each frame of the matching path can be calculated only upon considering the spectral change dₓ(i) of the speaker template X or the spectral change d_{y}(i) of the test utterance Y, or upon considering the combination of the spectral change dₓ(i) of the speaker template X or the spectral change d_{y}(i) of the test utterance Y, and the present invention has no limitation on this.

Further, it should be understood that the methods for measuring the weights by using spectral change are not limited to the above formula (2) to formula (4), and the weights can be measured by using any monotone increasing function of the spectral change, as long as that frames during rapid spectral change period are given high weights and that frames during low spectral change period are given low weights.

Return to step 104 of FIG. 1, after the weights for each frame of the matching path are calculated based on the spectral change of said test utterance and/or the spectral change of said speaker template, the matching score of the matching path is calculated based on the calculated weights for each frame of the matching path. Specifically, for example, the matching score of the matching path can be obtained by adding up all the products between the local distance of each frame of the matching path and the weight of the frame.

Last, in step 105, it is determined whether the matching score calculated in step 104 is smaller than the discriminating threshold set in the speaker template. If it is yes, the verification is successful that the password spoken by the same speaker is confirmed in step 106. If it is no, the verification is unsuccessful in step 107.

It can be known through the above description, the method for verification of speaker authentication of the present embodiment is an effective method of weighting frames based on spectral change. It is of low computation complexity and particularly suitable for most systems applying spectrum features. Employing the method for verification of speaker authentication, the speaker verification system can achieve remarkable improvement.

Further, the weighting method of the present embodiment is based on spectral change speed and does not conflict with other existing weighting methods such as the phone-based method. Thus, combining them together may achieve further improvement in performance.

### Second Embodiment

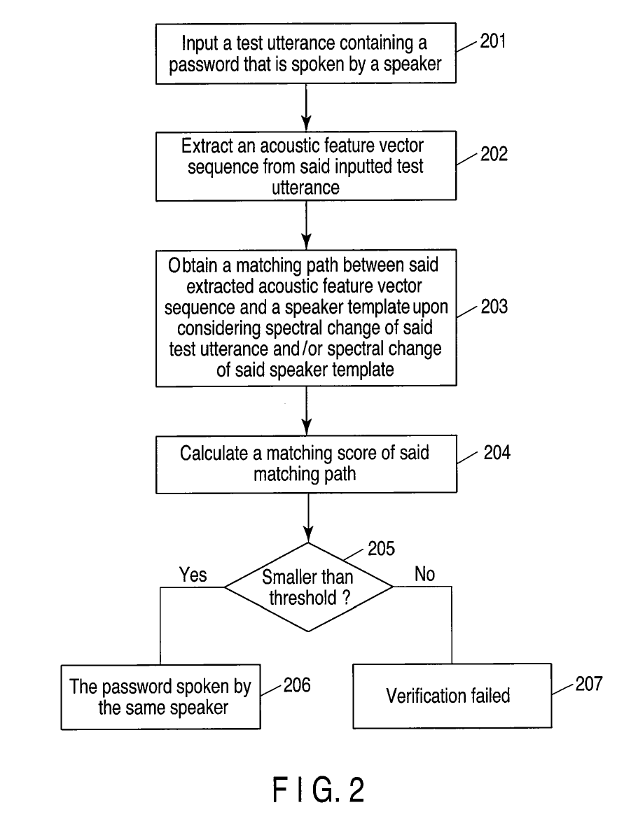

Based on the same concept of the invention, FIG. 2 is a flowchart showing a method for verification of speaker authentication according to a second embodiment of the present invention. The description of this embodiment will be given below in conjunction with FIG. 2, with a proper omission of the same content as those in the above-mentioned embodiments.

As shown in FIG. 2, in the second embodiment, step 201 and step 202 are similar with step 101 and step 102 of the first embodiment respectively, and the detail description thereof is omitted herein for clarity. After a test utterance containing a password is inputted in step 201 and an acoustic feature vector sequence is extracted in step 202 from the test utterance inputted in step 201, next, in step 203, the acoustic feature vector sequence extracted in step 202 and a speaker template is matched to obtain an optimal matching path upon considering spectral change of the test utterance and/or spectral change of the speaker template.

In step 203, first, weights for each frame pair corresponding to each frame of the acoustic feature vector sequence of the test utterance and each frame of the speaker template are calculated based on the spectral change of the test utterance and/or the spectral change of the speaker template. The speaker template of the present embodiment is similar with that of the first embodiment, the detail description of which is omitted herein for clarity

Specifically, in the embodiment, that frames during rapid spectral change period are given high weights and that frames during low spectral change period are given low weights. That is to say, in the embodiment, that frames during rapid spectral change period are emphasized.

The method of calculating the weights for each frame pair by using the spectral change in step 203 will be described in detail in follows by reference of examples 4-5.

### Example 4

In example 4, the weights for each frame pair are measured by feature distances between the target frame and its neighboring frames along a time sequence.

First, the spectral change dₓ(i) of the speaker template X and the spectral change d_{y}(i) of the test utterance Y are calculated respectively by using the above formula (1), the detail description of which is similar with that of the example 1 and omitted herein for clarity.

Then, the weights for each frame pair are calculated by a monotone increasing function of the spectral change dₓ(i) of the speaker template X and the spectral change d_{y}(i) of the test utterance Y. For example, the weights w(k) for each frame pair can be calculated by using the following formula (6) to formula (8):

w(g)=d(g)+c (6)

w(g)=d(g)^{a}+c (7)

w(g)=log(d(g)+c) (8)

wherein g is an index of a frame pair corresponding to the index i of the frame of the speaker template X and the index j of the frame of the test utterance Y, a and c are constant, and d(k) is one of dₓ(i), d_{y}(j), and any combination thereof such as (dₓ(i)+d_{y}(j))/2, \sqrt{dₓ(i)×d_{y}(j)}, min(dₓ(i),d_{y}(j)), max(dₓ(i),d_{y}(j)) etc.

### Example 5

In example 5, the weights for each frame pair are measured by segments obtained by using a code book.

The code book used in the present embodiment is one trained in the acoustic space of a whole application. For example, for a Chinese language application environment, the code book needs to cover the acoustic space of Chinese utterances; and for an English language application environment, the code book needs to cover the acoustic space of English utterances. Of course, for some special application environments, the acoustic space covered by the code book can be changed correspondingly.

The code book of the present embodiment contains a lot of codes and their corresponding feature vectors. The number of the codes depends on the size of the acoustic space, desired compression ratio and desired compression quality. The greater the acoustic space is, the more the number of the needed codes is. Under a condition of a same acoustic space, the less the number of the codes is, the higher the compression ratio is, and the more the number of the codes is, the higher the quality of the compressed template is. According to a preferred embodiment of the present invention, under an acoustic space of common Chinese utterances, the number of the codes is preferably 256-512. Of course, according to different needs, the number of the codes and the covered acoustic space of the code book can be adjusted appropriately.

In example 5, first, each frame of the acoustic feature vector sequence of the test utterance is labeled with a nearest code in the code book. Then, the test utterance is segmented based on the labels such that all the frames in one segment have a same label. Since the frames in a segment are similar with each other, the length of each segment may also be regarded as a kind of measurement for spectral change. Longer segment indicates slower spectral change at that place. Similarly, the spectral change of the speaker template can be measured by the length of each segment obtained by labeling each frame of the speaker template by using the code book and segmenting the speaker template based on the labels obtained.

In example 5, the weights for each frame pair can be calculated by using the formula (6) to formula (8) in example 4 except that dₓ(i) and d_{y}(j) are lengths of the segment where the target frame is located and therefore are discrete values. In this case, piecewise functions can be used as the functions used to transform spectral change into weights for each frame pair.

In the present embodiment, any type of piecewise functions can be used, such as w(g)=1, if d(g)≦10; w(g)=0.5, else, wherein g is an index of a frame pair corresponding to the index i of the frame of the speaker template X and the index j of the frame of the test utterance Y, and d(k) is one of dₓ(i), d_{y}(j), and any combination thereof such as (dₓ(i)+d_{y}(j))/2, \sqrt{dₓ(i)×d_{y}(j)}, min(dₓ(i),d_{y}(j)), max(dₓ(i),d_{y}(j)) etc., and the present invention has no limitation on this.

Although the weights for each frame pair are calculated by the methods described by using examples 4-5, the present invention is not limited to examples 4-5, and any method for measuring the weights for each frame pair by using spectral change can be used, as long as rapid and low spectral change can be transformed into high and low weights, and the present invention has no limitation on this.

It should be understood that in the methods described by using examples 4-5, the weights for each frame pair can be calculated only upon considering the spectral change dₓ(i) of the speaker template X or the spectral change d_{y}(i) of the test utterance Y, or upon considering the combination of the spectral change dₓ(i) of the speaker template X or the spectral change d_{y}(i) of the test utterance Y, and the present invention has no limitation on this.

Further, it should be understood that the methods for measuring the weights by using spectral change are not limited to the above formula (6) to formula (8), and the weights can be measured by using any monotone increasing function of the spectral change, as long as that frames during rapid spectral change period are given high weights and that frames during low spectral change period are given low weights.

Return to step 203 of FIG. 2, after the weights for each frame pair corresponding to each frame of the acoustic feature vector sequence of the test utterance and each frame of the speaker template are calculated based on the spectral change of said test utterance and/or the spectral change of said speaker template, the acoustic feature vector sequence extracted in step 202 and the speaker template is matched and the optimal matching path is obtained.

Specifically, for a HMM model, the matching path can be obtained by matching based on frequency, the detail description of which can be seen in above article 1. For a DTW model, the matching path can be obtained by the DTW algorithm, the detail description of which can be seen in the first embodiment described by reference of FIG. 3 and are omitted herein for clarity.

Next, in step 204, the matching score of the matching path obtained in step 203 is calculated. Specifically, for example, the matching score of the matching path can be obtained by adding up all the local distances of each frame of the matching path.

Last, in step 205, it is determined whether the matching score calculated in step 204 is smaller than the discriminating threshold set in the speaker template. If it is yes, the verification is successful that the password spoken by the same speaker is confirmed in step 206. If it is no, the verification is unsuccessful in step 207.

It can be known through the above description, the method for verification of speaker authentication of the present embodiment is an effective method of weighting frames based on spectral change. It is of low computation complexity and particularly suitable for most systems applying spectrum features. Employing the method for verification of speaker authentication, the speaker verification system can achieve remarkable improvement.

Further, the weighting method of the present embodiment is based on spectral change speed and does not conflict with other existing weighting methods such as the phone-based method. Thus, combining them together may achieve further improvement in performance.

Further, comparing with the verification method of the first embodiment, the spectral change of the test utterance and the spectral change of the speaker template are considered when searching the optimal matching path in the verification method of the present embodiment, thereby the obtained optimal matching path may be more accurate, and the performance of the system can be further improved.

Apparatus for verification of speaker authentication

### Third Embodiment

Based on the same concept of the invention, FIG. 4 is a block diagram showing an apparatus for verification of speaker authentication according to a third embodiment of the present invention. The description of this embodiment will be given below in conjunction with FIG. 2, with a proper omission of the same content as those in the above-mentioned embodiments.

As shown in FIG. 1, the apparatus 400 for verification of speaker authentication of the present embodiment comprises: a test utterance inputting unit 401 configured to input a test utterance containing a password that is spoken by a speaker; an acoustic feature vector sequence extractor 402 configured to extract an acoustic feature vector sequence from said inputted test utterance; a matching path obtaining unit 403 configured to obtain a matching path between said extracted acoustic feature vector sequence and a speaker template enrolled by an enrolled speaker; a matching score calculator 404 configured to calculate a matching score of said obtained matching path upon considering spectral change of said test utterance and/or spectral change of said speaker template; and a comparing unit 405 configured to compare said matching score with a predefined discriminating threshold to determine whether said inputted test utterance is an utterance containing a password spoken by the enrolled speaker.

In the embodiment, the test utterance containing a password is inputted by a client needed to be verified by using the test utterance inputting unit 401, wherein the password is a special term or phoneme sequence that is set by a client for verification in a phase of enrollment.

In the embodiment, the acoustic feature vector sequence is extracted by the acoustic feature vector sequence extractor 402 from the test utterance inputted by the test utterance inputting unit 401. The invention has no specific limitation to the way to express an acoustic feature, and it may be, for example, MFCC (Mel-scale Frequency Cepstral Coefficients), LPCC (Linear Predictive Cepstrum Coefficient) or other coefficients obtained based on energy, fundamental tone frequency, or wavelet analysis, as long as it can express personal utterance characteristics of a speaker; however, it should be corresponded with the way used to express an acoustic feature in the phase of enrollment.

In the embodiment, the acoustic feature vector sequence extracted by the acoustic feature vector sequence extractor 402 and a speaker template enrolled by an enrolled speaker is matched by matching path obtaining unit 403 and a matching path is obtained. Specifically, for a HMM model, the matching path can be obtained by matching based on frequency, the detail description of which can be seen in above article 1. For a DTW model, the matching path can be obtained by the DTW algorithm, the detail description of which will be given in follows by reference of FIG. 3.

FIG. 3 shows an example of DTW-matching between a test utterance and a speaker template. As shown in FIG. 3, the horizontal axis represents frames of the speaker template, and the vertical axis represents frames of the inputted utterance. When the DTW-matching is performed, local distances between each frame of the speaker template and a corresponding frame of the inputted utterance and adjacent frames thereof are calculated, and the frame of the inputted utterance, which has the smallest local distance, is selected as the frame corresponding to the frame of the speaker template. The step is repeated until each of all frames of the inputted utterance is found a corresponding frame of the speaker template, thereby an optimal matching path can be obtained. It should be understood that the method of the embodiment can be used in any known model besides the HMM model and the DTW model as long as the optimal matching path between the acoustic feature vector sequence extracted in step 102 and the speaker template can be obtained.

The speaker template in this embodiment is a speaker template generated by a method for enrollment of speaker authentication, which includes at least acoustic features corresponding to the password utterance and a discriminating threshold. The process for enrollment of speaker authentication will be described simply herein. First, an utterance containing the password spoken by the speaker is inputted. Next, an acoustic feature is extracted from the inputted password utterance. Then, the speaker template is produced. The speaker template can be built with a number of utterances for training in order to improve the quality of the speaker template. First, a training utterance is selected to be an initial template. Then, a second training utterance is aligned with the initial template by DTW method, and a new template is produced with the average of the corresponding feature vectors in the two utterances. Then, a third training utterance is aligned with the new template by the DTW method. The above process is repeated until all training utterances are merged to single template, that is, so-called template merging is made. About template merging, reference may be made to the article “Cross-words reference template for DTW-based speech recognition systems” written by W. H. Abdulla, D. Chow, and G. Sin(IEEE TENCON 2003, pp. 1576-1579).

Moreover, in the phase of enrollment of speaker authentication, the discriminating threshold contained in the speaker template can be determined in the following manner. First, two distributions of DTW-matching scores of the speaker and other people are obtained by collecting two big sets of utterance data containing a same password spoken by the speaker and spoken by other people respectively, and DTW-matching the two sets of utterance data with the trained speaker template, respectively. Then, the discriminating threshold for the speaker template can be estimated in at least the following three ways:

setting the discriminating threshold to the cross point of the two distribution curves, that is, the place where the sum of FAR (False Accept Rate) and FRR (False Reject Rate) is minimum;

setting the discriminating threshold to the value corresponding to EER (Equal Error Rate); or

setting the discriminating threshold to the value that makes false accept rate a desired value (such as 0.1%).

Back to FIG. 4, in the embodiment, the matching score of said matching path obtained by the matching path obtaining unit 403 is calculated by the matching score calculator 404 upon considering spectral change of said test utterance and/or spectral change of said speaker template.

In the embodiment, the matching score calculator 404 comprises a weight calculator 4041 configured to calculate weights for each frame of the matching path based on the spectral change of said test utterance and/or the spectral change of said speaker template.

Specifically, in the embodiment, the weight calculator 4041 gives high weights to that frames during rapid spectral change period and gives low weights to that frames during low spectral change period. That is to say, in the embodiment, that frames during rapid spectral change period are emphasized.

Specifically, the weight calculator 4041 comprises a spectral change calculator configured to calculate the spectral change of said test utterance and the spectral change of the speaker template, wherein the weight calculator 4041 is configured to calculate the weights for each frame of said matching path based on the spectral change calculated by the spectral change calculator. The process of calculating the spectral change of the spectral change calculator and the process of calculating the weights for each frame of said matching path of the weight calculator 4041 is similar with that of the first embodiment described by reference of examples 1-3, the detail description of which is omitted herein for clarity.

After the weights for each frame of the matching path are calculated by the weight calculator 4041 based on the spectral change of the test utterance and/or the spectral change of the speaker template, the matching score of the matching path is calculated by the matching score calculator 404 based on the weights for each frame of the matching path calculated by the weight calculator 4041. Specifically, for example, the matching score of the matching path can be obtained by adding up all the products between the local distance of each frame of the matching path and the weight of the frame.

In the embodiment, the comparing unit 405 is configured to determine whether the matching score calculated by the matching score calculator 404 is smaller than the discriminating threshold set in the speaker template. If it is yes, the verification is successful that the password spoken by the same speaker is confirmed. If it is no, the verification is failed.

It can be known through the above description, the apparatus 400 for verification of speaker authentication of the present embodiment is an effective apparatus of weighting frames based on spectral change. It is of low computation complexity and particularly suitable for most systems applying spectrum features. Employing the apparatus 400 for verification of speaker authentication, the speaker verification system can achieve remarkable improvement.

Further, the weighting apparatus 400 of the present embodiment is based on spectral change speed and does not conflict with other existing weighting apparatuses such as the phone-based apparatus. Thus, combining them together may achieve further improvement in performance.

### Fourth Embodiment

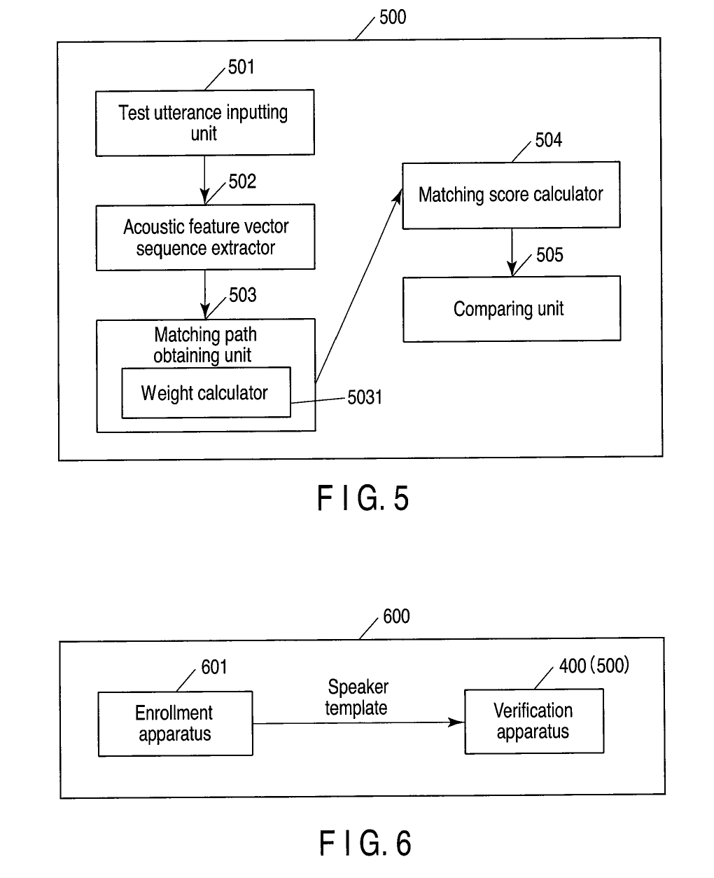

Based on the same concept of the invention, FIG. 5 is a block diagram showing an apparatus for verification of speaker authentication according to a fourth embodiment of the present invention. The description of this embodiment will be given below in conjunction with FIG. 5, with a proper omission of the same content as those in the above-mentioned embodiments.

As shown in FIG. 1, the apparatus 500 for verification of speaker authentication of the present embodiment comprises: a test utterance inputting unit 501 configured to input a test utterance containing a password that is spoken by a speaker; an acoustic feature vector sequence extractor 502 configured to extract an acoustic feature vector sequence from said inputted test utterance; a matching path obtaining unit 503 configured to obtain a matching path between said extracted acoustic feature vector sequence and a speaker template enrolled by an enrolled speaker upon considering spectral change of said test utterance and/or spectral change of said speaker template; a matching score calculator 504 configured to calculate a matching score of said obtained matching path; and a comparing unit 505 configured to compare said matching score with a predefined discriminating threshold to determine whether said inputted test utterance is an utterance containing a password spoken by the enrolled speaker.

In the fourth embodiment, the test utterance inputting unit 501 and the acoustic feature vector sequence extractor 502 are similar with the test utterance inputting unit 401 and the acoustic feature vector sequence extractor 402 of the first embodiment respectively, and the detail description thereof is omitted herein for clarity. After a test utterance containing a password is inputted by the test utterance inputting unit 501 and an acoustic feature vector sequence is extracted by the acoustic feature vector sequence extractor 502 from the test utterance, the acoustic feature vector sequence extracted by the acoustic feature vector sequence extractor 502 and a speaker template is matched by the matching path obtaining unit 503 to obtain an optimal matching path upon considering spectral change of the test utterance and/or spectral change of the speaker template.

In the embodiment, the matching path obtaining unit 503 comprises a weight calculator 5031 configured to calculate the weights for each frame pair corresponding to each frame of the acoustic feature vector sequence of the test utterance and each frame of the speaker template based on the spectral change of the test utterance and/or the spectral change of the speaker template. The speaker template of the present embodiment is similar with that of the above embodiment, the detail description of which is omitted herein for clarity

Specifically, in the embodiment, the weight calculator 5031 gives high weights to that frames during rapid spectral change period and gives low weights to that frames during low spectral change period. That is to say, in the embodiment, that frames during rapid spectral change period are emphasized.

Specifically, the weight calculator 5013 comprises a spectral change calculator configured to calculate the spectral change of said test utterance and the spectral change of the speaker template, wherein the weight calculator 5013 is configured to calculate the weights for each frame pair based on the spectral change calculated by the spectral change calculator. The process of calculating the spectral change of the spectral change calculator and the process of calculating the weights for each frame pair of the weight calculator 5031 is similar with that of the second embodiment described by reference of examples 4-5, the detail description of which is omitted herein for clarity.

After the weights for each frame pair corresponding to each frame of the acoustic feature vector sequence of the test utterance and each frame of the speaker template are calculated by the weight calculator 5031 based on the spectral change of said test utterance and/or the spectral change of said speaker template, the acoustic feature vector sequence extracted by the acoustic feature vector sequence extractor 502 and the speaker template is matched and the optimal matching path is obtained by the matching path obtaining unit 503.

Specifically, for a HMM model, the matching path can be obtained by matching based on frequency, the detail description of which can be seen in above article 1. For a DTW model, the matching path can be obtained by the DTW algorithm, the detail description of which can be seen in the first embodiment described by reference of FIG. 3 and are omitted herein for clarity.

In the embodiment, the matching score of the matching path obtained by the matching path obtaining unit 503 is calculated by the matching score calculator 504. Specifically, for example, the matching score of the matching path can be obtained by adding up all the local distances of each frame of the matching path.

In the embodiment, the comparing unit 505 is configured to determine whether the matching score calculated by the matching score calculator 504 is smaller than the discriminating threshold set in the speaker template. If it is yes, the verification is successful that the password spoken by the same speaker is confirmed. If it is no, the verification is failed.

It can be known through the above description, the apparatus 500 for verification of speaker authentication of the present embodiment is an effective apparatus of weighting frames based on spectral change. It is of low computation complexity and particularly suitable for most systems applying spectrum features. Employing the apparatus 500 for verification of speaker authentication, the speaker verification system can achieve remarkable improvement.

Further, the weighting apparatus 500 of the present embodiment is based on spectral change speed and does not conflict with other existing weighting apparatuses such as the phone-based apparatus. Thus, combining them together may achieve further improvement in performance.

Further, comparing with the verification apparatus 400 of the third embodiment, the spectral change of the test utterance and the spectral change of the speaker template are considered when searching the optimal matching path in the verification apparatus 500 of the present embodiment, thereby the obtained optimal matching path may be more accurate, and the performance of the verification apparatus 400 can be further improved.

System for speaker authentication

### Fifth Embodiment

Based on the same concept of the invention, FIG. 6 is a block diagram showing a system for speaker authentication according to a fifth embodiment of the present invention. The description of this embodiment will be given below in conjunction with FIG. 6, with a proper omission of the same content as those in the above-mentioned embodiments.

As shown in FIG. 6, the system 600 for speaker authentication in this embodiment comprises: an enrollment apparatus 601 configured to enroll a speaker template; and the apparatus 400 or 500 for verification of speaker authentication described in the above-mentioned embodiment configured to verify a test utterance based on said speaker template enrolled by said enrollment apparatus 601. The speaker template generated by the enrollment apparatus 601 is transferred to the verification apparatus 400 or 500 via any communication means, such as a network, an internal channel, a disk or other recording media.

It can be known through the above description, the system 600 for speaker authentication of the present embodiment is an effective system of weighting frames based on spectral change. It is of low computation complexity and particularly suitable for most systems applying spectrum features. Employing the system 600 for speaker authentication, the speaker verification system can achieve remarkable improvement.

Further, the system 600 for speaker authentication of the present embodiment does not conflict with other existing weighting systems such as the phone-based system. Thus, combining them together may achieve further improvement in performance.

Though the method for verification of speaker authentication, the apparatus for verification of speaker authentication and the system for speaker authentication have been described in details with some exemplary embodiments, these above embodiments are not exhaustive. Those skilled in the art may make various variations and modifications within the spirit and scope of the present invention. Therefore, the present invention is not limited to these embodiments; rather, the scope of the present invention is only defined by the appended claims.

Preferably, in the method for verification of speaker authentication, the step of calculating a matching score of said obtained matching path upon considering spectral change of said test utterance and/or spectral change of said speaker template comprises: calculating weights for each frame of said matching path based on said spectral change of said test utterance and/or said spectral change of said speaker template; and calculating said matching score of said matching path based on said calculated weights.

Preferably, in the method for verification of speaker authentication, the step of calculating weights for each frame of said matching path based on said spectral change of said test utterance and/or said spectral change of said speaker template comprises: calculating said spectral change of said test utterance based on said extracted acoustic feature vector sequence; and calculating said weights based on said calculated spectral change of said test utterance.

Preferably, in the method for verification of speaker authentication, the step of calculating said spectral change of said test utterance based on said extracted acoustic feature vector sequence comprises: calculating said spectral change of said test utterance based on feature distances between each frame of said acoustic feature vector sequence of said test utterance and its neighboring frames along a time sequence.

Preferably, in the method for verification of speaker authentication, said spectral change of said test utterance on said frame is measured by an average value of feature distances between said frame of said acoustic feature vector sequence of said test utterance and its neighboring frames along a time sequence.

Preferably, in the method for verification of speaker authentication, the step of calculating said spectral change of said test utterance based on said extracted acoustic feature vector sequence comprises: calculating said spectral change of said test utterance based on feature distances between each frame of said acoustic feature vector sequence of said test utterance and frames in its neighboring nodes along said matching path.

Preferably, in the method for verification of speaker authentication, said spectral change of said test utterance on said frame is measured by an average value of said feature distances between said frame of said acoustic feature vector sequence of said test utterance and frames in its neighboring nodes along said matching path.

Preferably, in the method for verification of speaker authentication, the step of calculating said spectral change of said test utterance based on said extracted acoustic feature vector sequence comprises: calculating said spectral change of said test utterance based on a code book.

Preferably, in the method for verification of speaker authentication, the step of calculating said spectral change of said test utterance based on a code book comprises: labeling each frame of said acoustic feature vector sequence of said test utterance with a nearest code in said code book; segmenting said test utterance based on said labels such that all the frames in one segment have a same label; and calculating a length of each segment, wherein spectral change of each frame corresponding to said segment is measured by said length of said segment.

Preferably, in the method for verification of speaker authentication, the step of calculating weights for each frame of said matching path based on said spectral change of said test utterance and/or said spectral change of said speaker template comprises: calculating said spectral change of said speaker template based on an acoustic feature vector sequence of said speaker template; and calculating said weights based on said calculated spectral change of said speaker template.

Preferably, in the method for verification of speaker authentication, the step of calculating said spectral change of said speaker template based on an acoustic feature vector sequence of said speaker template comprises: calculating said spectral change of said speaker template based on feature distances between each frame of said speaker template and its neighboring frames along a time sequence.

Preferably, in the method for verification of speaker authentication, said spectral change of said speaker template on said frame is measured by an average value of said feature distances between said frame of said speaker template and its neighboring frames along a time sequence.

Preferably, in the method for verification of speaker authentication, the step of calculating said spectral change of said speaker template based on an acoustic feature vector sequence of said speaker template comprises: calculating said spectral change of said speaker template based on feature distances between each frame of said speaker template and frames in its neighboring nodes along said matching path.

Preferably, in the method for verification of speaker authentication, said spectral change of said speaker template on said frame is measured by an average value of said feature distances between said frame of said speaker template and frames in its neighboring nodes along said matching path.

Preferably, in the method for verification of speaker authentication, the step of calculating said spectral change of said speaker template based on an acoustic feature vector sequence of said speaker template comprises: calculating said spectral change of said speaker template based on a code book.

Preferably, in the method for verification of speaker authentication, the step of calculating said spectral change of said speaker template based on a code book comprises: labeling each frame of said speaker template with a nearest code in said code book; segmenting said speaker template based on said labels such that all the frames in one segment have a same label; and calculating a length of each segment, wherein spectral change of each frame corresponding to said segment is measured by said length of said segment.

Preferably, in the method for verification of speaker authentication, the step of calculating weights for each frame of said matching path based on said spectral change of said test utterance and/or said spectral change of said speaker template comprises: calculating said weights for each frame of said matching path as a monotone increasing function of said spectral change of said test utterance, said spectral change of said speaker template or a combination thereof.

Preferably, in the method for verification of speaker authentication, the step of obtaining a matching path between said extracted acoustic feature vector sequence and a speaker template enrolled by an enrolled speaker comprises: DTW-matching said extracted acoustic feature vector sequence and said speaker template.

Preferably, in the method for verification of speaker authentication, the step of obtaining a matching path between said extracted acoustic feature vector sequence and a speaker template enrolled by an enrolled speaker upon considering spectral change of said test utterance and/or spectral change of said speaker template comprises: calculating weights for each frame of said acoustic feature vector sequence of said test utterance based on said spectral change of said test utterance; and matching said extracted acoustic feature vector sequence and said speaker template upon considering said calculated weights.

Preferably, in the method for verification of speaker authentication, the step of calculating weights for each frame of said acoustic feature vector sequence of said test utterance based on said spectral change of said test utterance comprises: calculating said spectral change of said test utterance based on said extracted acoustic feature vector sequence; and calculating weights for each frame of said acoustic feature vector sequence of said test utterance based on based on said calculated spectral change of said test utterance.

Preferably, in the method for verification of speaker authentication, the step of calculating said spectral change of said test utterance based on said extracted acoustic feature vector sequence comprises: calculating said spectral change of said test utterance based on feature distances between each frame of said acoustic feature vector sequence of said test utterance and its neighboring frames along a time sequence.

Preferably, in the method for verification of speaker authentication, said spectral change of said test utterance on said frame is measured by an average value of feature distances between said frame of said acoustic feature vector sequence of said test utterance and its neighboring frames along a time sequence.

Preferably, in the method for verification of speaker authentication, the step of calculating said spectral change of said test utterance based on said extracted acoustic feature vector sequence comprises: calculating said spectral change of said test utterance based on a code book.

Preferably, in the method for verification of speaker authentication, the step of calculating said spectral change of said test utterance based on a code book comprises: labeling each frame of said acoustic feature vector sequence of said test utterance with a nearest code in said code book; segmenting said test utterance based on said labels such that all the frames in one segment have a same label; and calculating a length of each segment, wherein spectral change of each frame corresponding to said segment is measured by said length of said segment.

Preferably, in the method for verification of speaker authentication, the step of obtaining a matching path between said extracted acoustic feature vector sequence and a speaker template enrolled by an enrolled speaker upon considering spectral change of said test utterance and/or spectral change of said speaker template comprises: calculating weights for each frame of said speaker template based on said spectral change of said speaker template; and matching said extracted acoustic feature vector sequence and said speaker template upon considering said calculated weights.

Preferably, in the method for verification of speaker authentication, the step of calculating weights for each frame of said speaker template based on said spectral change of said speaker template comprises: calculating said spectral change of said speaker template based on an acoustic feature vector sequence of said speaker template; and calculating weights for each frame of said speaker template based on said calculated spectral change of said speaker template.

Preferably, in the method for verification of speaker authentication, the step of calculating said spectral change of said speaker template based on an acoustic feature vector sequence of said speaker template comprises: calculating said spectral change of said speaker template based on feature distances between each frame of said speaker template and its neighboring frames along a time sequence.

Preferably, in the method for verification of speaker authentication, said spectral change of said speaker template on said frame is measured by an average value of said feature distances between said frame of said speaker template and its neighboring frames along a time sequence.

Preferably, in the method for verification of speaker authentication, the step of calculating said spectral change of said speaker template based on an acoustic feature vector sequence of said speaker template comprises: calculating said spectral change of said speaker template based on a code book.

Preferably, in the method for verification of speaker authentication, the step of calculating said spectral change of said speaker template based on a code book comprises: labeling each frame of said speaker template with a nearest code in said code book; segmenting said speaker template based on said labels such that all the frames in one segment have a same label; and calculating a length of each segment, wherein spectral change of each frame corresponding to said segment is measured by said length of said segment.

Preferably, in the method for verification of speaker authentication, the step of obtaining a matching path between said extracted acoustic feature vector sequence and a speaker template enrolled by an enrolled speaker comprises: DTW-matching said extracted acoustic feature vector sequence and said speaker template.

What is claimed is:

1. A method for verification of speaker authentication, comprising:
inputting a test utterance containing a password that is spoken by a speaker;
extracting an acoustic feature vector sequence from said inputted test utterance;
obtaining a matching path between said extracted acoustic feature vector sequence and a speaker template enrolled by an enrolled speaker;
calculating a matching score of said obtained matching path upon considering spectral change of said test utterance and/or spectral change of said speaker template; and
comparing said matching score with a predefined discriminating threshold to determine whether said inputted test utterance is an utterance containing a password spoken by the enrolled speaker.

2. A method for verification of speaker authentication, comprising:
inputting a test utterance containing a password that is spoken by a speaker;
extracting an acoustic feature vector sequence from said inputted test utterance;
obtaining a matching path between said extracted acoustic feature vector sequence and a speaker template enrolled by an enrolled speaker upon considering spectral change of said test utterance and/or spectral change of said speaker template;
calculating a matching score of said obtained matching path; and
comparing said matching score with a predefined discriminating threshold to determine whether said inputted test utterance is an utterance containing a password spoken by the enrolled speaker.

3. A apparatus for verification of speaker authentication, comprising:
a test utterance inputting unit configured to input a test utterance containing a password that is spoken by a speaker;
an acoustic feature vector sequence extractor configured to extract an acoustic feature vector sequence from said inputted test utterance;
a matching path obtaining unit configured to obtain a matching path between said extracted acoustic feature vector sequence and a speaker template enrolled by an enrolled speaker;
a matching score calculator configured to calculate a matching score of said obtained matching path upon considering spectral change of said test utterance and/or spectral change of said speaker template; and
a comparing unit configured to compare said matching score with a predefined discriminating threshold to determine whether said inputted test utterance is an utterance containing a password spoken by the enrolled speaker.

4. The apparatus for verification of speaker authentication according to claim 3, wherein said matching score calculator comprises:
a weight calculator configured to calculate weights for each frame of said matching path based on said spectral change of said test utterance and/or said spectral change of said speaker template,
wherein said matching score calculator is configured to calculate said matching score of said matching path based on said weights calculated by said weight calculator.

5. The apparatus for verification of speaker authentication according to claim 4, wherein said weight calculator comprises:
a spectral change calculator configured to calculate said spectral change of said test utterance based on said extracted acoustic feature vector sequence,
wherein said weight calculator is configured to calculate said weights based on said spectral change of said test utterance calculated by said spectral change calculator.

6. The apparatus for verification of speaker authentication according to claim 5, wherein said spectral change calculator is configured to:
calculate said spectral change of said test utterance based on feature distances between each frame of said acoustic feature vector sequence of said test utterance and its neighboring frames along a time sequence.

7. The apparatus for verification of speaker authentication according to claim 6, wherein said spectral change of said test utterance on said frame is measured by an average value of feature distances between said frame of said acoustic feature vector sequence of said test utterance and its neighboring frames along a time sequence.

8. The apparatus for verification of speaker authentication according to claim 5, wherein said spectral change calculator is configured to:
calculate said spectral change of said test utterance based on feature distances between each frame of said acoustic feature vector sequence of said test utterance and frames in its neighboring nodes along said matching path.

9. The apparatus for verification of speaker authentication according to claim 8, wherein said spectral change of said test utterance on said frame is measured by an average value of said feature distances between said frame of said acoustic feature vector sequence of said test utterance and frames in its neighboring nodes along said matching path.

10. The apparatus for verification of speaker authentication according to claim 5, said spectral change calculator is configured to:
calculate said spectral change of said test utterance based on a code book.

11. The apparatus for verification of speaker authentication according to claim 10, wherein said spectral change calculator is configured to:
label each frame of said acoustic feature vector sequence of said test utterance with a nearest code in said code book;
segment said test utterance based on said labels such that all the frames in one segment have a same label; and
calculate a length of each segment, wherein spectral change of each frame corresponding to said segment is measured by said length of said segment.

12. The apparatus for verification of speaker authentication according to claim 4, wherein said weight calculator comprises:
a spectral change calculator configured to calculate said spectral change of said speaker template based on an acoustic feature vector sequence of said speaker template,
wherein said weight calculator is configured to calculate said weights based on said calculated spectral change of said speaker template.

13. The apparatus for verification of speaker authentication according to claim 12, wherein said spectral change calculator is configured to:
calculate said spectral change of said speaker template based on feature distances between each frame of said speaker template and its neighboring frames along a time sequence.

14. The apparatus for verification of speaker authentication according to claim 13, wherein said spectral change of said speaker template on said frame is measured by an average value of said feature distances between said frame of said speaker template and its neighboring frames along a time sequence.

15. The apparatus for verification of speaker authentication according to claim 12, wherein said spectral change calculator is configured to:
calculate said spectral change of said speaker template based on feature distances between each frame of said speaker template and frames in its neighboring nodes along said matching path.

16. The apparatus for verification of speaker authentication according to claim 15, wherein said spectral change of said speaker template on said frame is measured by an average value of said feature distances between said frame of said speaker template and frames in its neighboring nodes along said matching path.

17. The apparatus for verification of speaker authentication according to claim 12, wherein said spectral change calculator is configured to:
calculate said spectral change of said speaker template based on a code book.

18. The apparatus for verification of speaker authentication according to claim 17, wherein said spectral change calculator is configured to:
label each frame of said speaker template with a nearest code in said code book;
segment said speaker template based on said labels such that all the frames in one segment have a same label; and
calculate a length of each segment, wherein spectral change of each frame corresponding to said segment is measured by said length of said segment.

19. The apparatus for verification of speaker authentication according to claim 4, wherein said weight calculator is configured to:
calculate said weights for each frame of said matching path as a monotone increasing function of said spectral change of said test utterance, said spectral change of said speaker template or a combination thereof.

20. The apparatus for verification of speaker authentication according to claim 3, wherein said matching path obtaining unit is configured to:
DTW-match said extracted acoustic feature vector sequence and said speaker template.

21. An apparatus for verification of speaker authentication, comprising:
a test utterance inputting unit configured to input a test utterance containing a password that is spoken by a speaker;
an acoustic feature vector sequence extractor configured to extract an acoustic feature vector sequence from said inputted test utterance;
a matching path obtaining unit configured to obtain a matching path between said extracted acoustic feature vector sequence and a speaker template enrolled by an enrolled speaker upon considering spectral change of said test utterance and/or spectral change of said speaker template;
a matching score calculator configured to calculate a matching score of said obtained matching path; and
a comparing unit configured to compare said matching score with a predefined discriminating threshold to determine whether said inputted test utterance is an utterance containing a password spoken by the enrolled speaker.

22. The apparatus for verification of speaker authentication according to claim 21, wherein said matching path obtaining unit comprises:
a weight calculator configured to calculate weights for each frame of said acoustic feature vector sequence of said test utterance based on said spectral change of said test utterance,
wherein said matching path obtaining unit is configured to match said extracted acoustic feature vector sequence and said speaker template upon considering said calculated weights.

23. The apparatus for verification of speaker authentication according to claim 22, wherein said weight calculator comprises:
a spectral change calculator configured to calculate said spectral change of said test utterance based on said extracted acoustic feature vector sequence,
wherein said weight calculator is configured to calculate weights for each frame of said acoustic feature vector sequence of said test utterance based on based on said calculated spectral change of said test utterance.

24. The apparatus for verification of speaker authentication according to claim 23, wherein said spectral change calculator is configured to:
calculate said spectral change of said test utterance based on feature distances between each frame of said acoustic feature vector sequence of said test utterance and its neighboring frames along a time sequence.

25. The apparatus for verification of speaker authentication according to claim 24, wherein said spectral change of said test utterance on said frame is measured by an average value of feature distances between said frame of said acoustic feature vector sequence of said test utterance and its neighboring frames along a time sequence.

26. The apparatus for verification of speaker authentication according to claim 23, wherein said spectral change calculator is configured to:
calculate said spectral change of said test utterance based on a code book.

27. The apparatus for verification of speaker authentication according to claim 26, wherein said spectral change calculator is configured to:
label each frame of said acoustic feature vector sequence of said test utterance with a nearest code in said code book;
segment said test utterance based on said labels such that all the frames in one segment have a same label; and
calculate a length of each segment, wherein spectral change of each frame corresponding to said segment is measured by said length of said segment.

28. The apparatus for verification of speaker authentication according to claim 21, wherein said matching path obtaining unit comprises:
a weight calculator configured to calculate weights for each frame of said speaker template based on said spectral change of said speaker template,
wherein said matching path obtaining unit is configured to match said extracted acoustic feature vector sequence and said speaker template upon considering said calculated weights.

29. The apparatus for verification of speaker authentication according to claim 28, wherein said weight calculator comprises:
a spectral change calculator configured to calculate said spectral change of said speaker template based on an acoustic feature vector sequence of said speaker template,
wherein said weight calculator is configured to calculate weights for each frame of said speaker template based on said calculated spectral change of said speaker template.

30. The apparatus for verification of speaker authentication according to claim 29, wherein said spectral change calculator is configured to:
calculate said spectral change of said speaker template based on feature distances between each frame of said speaker template and its neighboring frames along a time sequence.

31. The apparatus for verification of speaker authentication according to claim 30, wherein said spectral change of said speaker template on said frame is measured by an average value of said feature distances between said frame of said speaker template and its neighboring frames along a time sequence.

32. The apparatus for verification of speaker authentication according to claim 29, wherein said spectral change calculator is configured to:
calculate said spectral change of said speaker template based on a code book.

33. The apparatus for verification of speaker authentication according to claim 32, wherein said spectral change calculator is configured to:
label each frame of said speaker template with a nearest code in said code book;
segment said speaker template based on said labels such that all the frames in one segment have a same label; and
calculate a length of each segment, wherein spectral change of each frame corresponding to said segment is measured by said length of said segment.

34. The apparatus for verification of speaker authentication according to claim 21, wherein the step of obtaining a matching path between said extracted acoustic feature vector sequence and a speaker template enrolled by an enrolled speaker is configured to:
DTW-match said extracted acoustic feature vector sequence and said speaker template.

35. A system for speaker authentication, comprising:
an enrollment apparatus configured to enroll a speaker template; and
the apparatus for verification of speaker authentication according to claim 3 or 21, configured to verify a test utterance based on said speaker template enrolled by said enrollment apparatus.
